(19) United States
(12) Patent Application Publication
(10) Pub. No.: US 2005/0073608 A1
(43) Pub. Date: Apr. 7, 2005

(54) Method and system for passing closed caption data over a digital visual interface or high definition multimedia interface

(76) Inventors: Christopher J. Stone, Newtown, PA (US); Albert F. Elcock, Havertown, PA (US); Joseph F. Halgas JR., Huntingdon Valley, PA (US); John P. Kamieniecki, Lafayette Hill, PA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/677,675

(22) Filed: Oct. 2, 2003

(51) Int. Cl. H04N 7/00; H04N 5/445

(52) U.S. Cl. 348/468; 348/473; 348/563

(57) ABSTRACT

A method for selectively passing closed caption data from a source device to a display device includes receiving a data signal including un-rendered closed caption data and video data in the source device, separating the video data from the un-rendered closed caption data, determining closed caption processing capabilities of the display device, and if the display device is configured to process un-rendered closed caption data, transmitting the un-rendered closed caption data to the display device.

### FIELD

The present method and system relate to delivering closed caption data to a display device. More particularly, the present method and system provide for passing closed caption data over a digital visual interface or high definition multimedia interface to a display device.

### BACKGROUND

In addition to the video and audio program portions of a video presentation, video signals include auxiliary information. An example of auxiliary data contained in a television signal is closed caption data, which is included in line 21 of field 1. Digital television signals typically include packets or groups of data. Each packet represents a particular type of information such as video, audio, or auxiliary information.

A video receiver traditionally processed both video information and auxiliary information received as an input signal to produce an output signal that is suitable for coupling to a display device. Enabling an auxiliary information display feature such as closed captioning on a traditional video receiver causes the video receiver to produce an output video signal that includes one signal component representing video information and another signal component representing the auxiliary information. A displayed image produced in response to the output video signal includes a main image region representing the video information component of the output signal and a smaller image region that is inset into the main region of the display. In the case of closed captioning, a caption displayed in the small region provides a visible representation of audio information, such as speech, that is included in the audio program portion of a television program.

When using a digital visual interface (DVI) and/or a high definition multimedia interface (HDMI) link with the video receiver, a single digital video signal is transmitted. Traditional DVI/HDMI implementations require the video receiver to process and render closed captioning and then insert the rendered closed captions in the video signal. Thus when closed captioning is enabled, all devices coupled to the video receiver are sent and subsequently display closed captioning. In a multiple display device setting, the user of one display device may want to view closed captioning while the user of another display device does not desire to view the closed captioning.

### SUMMARY

A method for selectively passing closed caption data from a source device to a display device includes receiving a data signal including un-rendered closed caption data and video data in the source device, separating the video data from the un-rendered closed caption data, determining closed caption processing capabilities of the display device, and if the display device is configured to process un-rendered closed caption data, transmitting the un-rendered closed caption data to the display device.

### BRIEF DESCRIPTION OF THE DRAWINGS

The accompanying drawings illustrate various embodiments of the present method and system and are a part of the specification. Together with the following description, the drawings demonstrate and explain the principles of the present method and system. The illustrated embodiments are examples of the present method and system and do not limit the scope thereof.

FIG. 1 is a block diagram illustrating a communications setup configured to receive and selectively pass closed caption data to display devices according to one exemplary embodiment.

FIG. 2 is a block diagram illustrating the components of a receiving device configured to selectively pass closed caption data to display devices according to one exemplary embodiment.

FIG. 3 is a flow chart illustrating a method of selectively passing closed caption data to display devices according to one exemplary embodiment.

FIG. 4 is a block diagram illustrating a communications setup incorporating the present system and method according to one exemplary embodiment.

FIG. 5 is a representative view illustrating a modified monitor descriptor block according to one exemplary embodiment.

Throughout the drawings, identical reference numbers designate similar, but not necessarily identical, elements.

### DETAILED DESCRIPTION

The present specification describes a method and a system for selectively passing close caption data over a Digital Visual Interface (DVI) and/or High Definition Multimedia Interface (HDMI) for rendering in a display device. More specifically, the present method and system include determining whether a display device is configured to receive and render closed caption data. If so, the present system and method passes the closed caption data through the DVI and/or HDMI un-rendered, thereby allowing the display device the option of locally rendering the closed caption data.

In the present specification and in the appended claims, the term “Digital Visual Interface” or “DVI” is meant to be understood broadly as any connector or port that accommodates analog and digital display devices with a single connector. Similarly, the term “High Definition Multimedia Interface” or “HDMI” shall be interpreted as any connector or port that combines video and audio into a single digital interface for use with digital versatile disc (DVD) players, digital television (DTV) players, set-top boxes, or any other audiovisual devices. Additionally, the term “closed caption” is meant to be understood broadly as any textual or graphical representation of audio presented as a part of a television, movie, audio, computer, or other presentation.

A “transmitter” or a “source device” is meant to be understood as any electrical component such as a set-top box that is configured to receive a signal from a head-end unit or other signal source and subsequently transmit that signal to a number of sink devices. A “set-top box” is meant to be understood broadly as any device that enables a television set to become a user interface to the Internet or enables an analog television set to receive and decode digital television (DTV) broadcasts. A “sink device” is any display device or other receiver configured to receive a signal from a transmitter or source device through a DVI or HDMI connection including, but in no way limited to, a projector, a high-definition television, or a computer monitor. The term “render” is to be understood as processing received closed caption data from its broadcast form into display commands that may be processed by a display device.

In the following description, for purposes of explanation, numerous specific details are set forth in order to provide a thorough understanding of the present method and system for passing close caption data over a digital visual interface and/or high definition multimedia interface. It will be apparent, however, to one skilled in the art that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Overall Structure

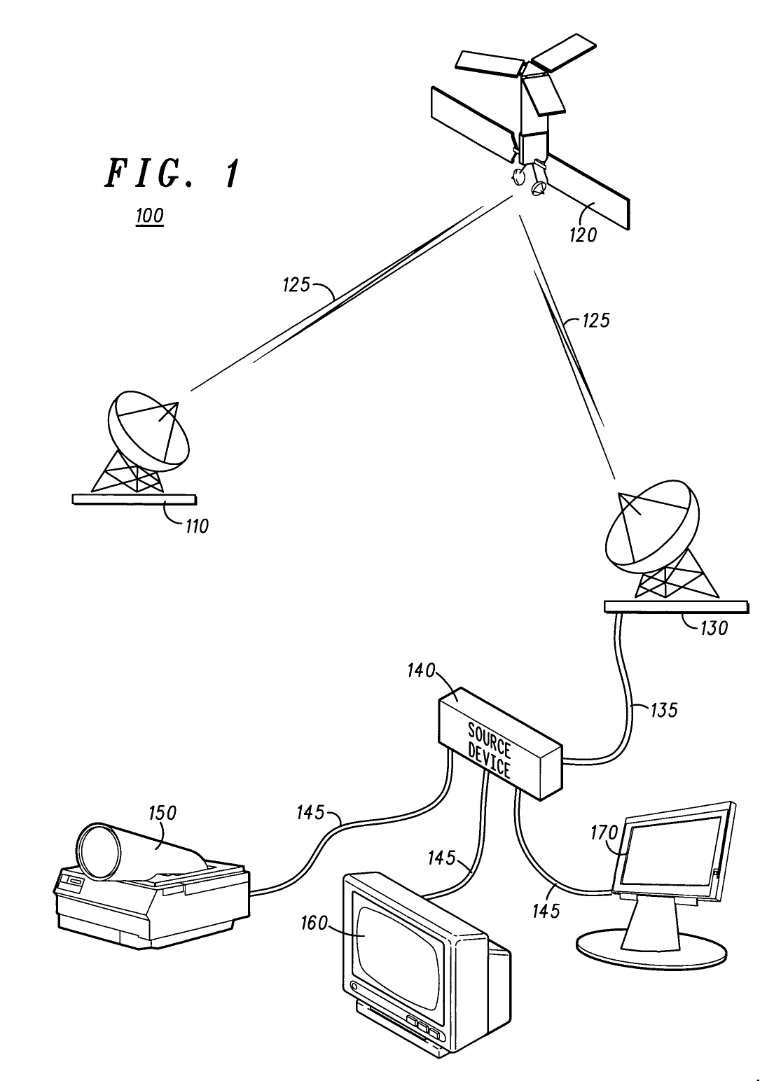

FIG. 1 illustrates a communications setup configured to receive and selectively pass closed caption data to display devices according to one exemplary embodiment. As shown in FIG. 1, the exemplary setup (100) includes a signal broadcaster (110) transmitting a signal (125) off of a satellite (120) or signal relay to a head-end unit (130). The head-end unit (130) is then communicatively coupled to a source device (140) such as a set-top box (STB). The head-end unit (130) is communicatively coupled to the source device (140) through a transmission medium (135) as shown in FIG. 1. The source device (140) is, in turn, communicatively coupled to a number of sink devices (150, 160, 170) via a digital visual interface (DVI) and/or high-definition multimedia interface (HDMI) (145). The individual components of the exemplary setup (100) illustrated in FIG. 1 will now be described in further detail below.

As shown in FIG. 1, the video signal and its accompanying audio signal originate at a signal broadcaster (110). A signal broadcaster (110) may be any company or system configured to transmit a video signal including closed caption data to a more locally located head-end unit (130). As shown in FIG. 1, the signal broadcaster (110) may be communicatively coupled to a head-end unit by transmitting the video signal off of a satellite (120). Once received by the satellite (120) or other signal relay device, the video signal is then transmitted to the head-end unit (130). While the embodiment illustrated in FIG. 1 shows the signal broadcaster (110) and the head-end unit (130) as satellite dishes communicatively coupled to a satellite (120), the video signal may be transmitted in a number of ways including, but in no way limited to, a satellite dish, fiber-optic cable, coaxial cable, phone line (twisted pair cables), etc.

Once the signal (125) is communicated to the head-end unit (130), the signal is transmitted to a number of subscribers through a transmission medium (135). A head-end unit (130) is a facility or component at a local signal transmission office that originates, relays, and/or communicates cable TV services and cable modem services to subscribers. In distributing cable television services, the head-end unit (130) typically includes a satellite dish antenna for receiving incoming programming from the broadcasting station (110).

The head-end unit (130) is communicatively coupled to the source device (140) through a transmission medium (135). The transmission medium (140) communicatively coupling the head-end unit (130) and the source device (140) may be any medium capable of transmitting digital video and closed caption data including, but in no way limited to, coaxial cable, fiber-optic cable, satellite transmission, radio wave transmission, etc.

The source device (140) illustrated in FIG. 1 may be any type of circuitry configured to receive a video signal including closed caption data from a head-end unit (130) and selectively transmit that video signal to a sink device (150, 160, 170). According to one exemplary embodiment illustrated in FIG. 1, the source device (140) may be a set-top box. A set-top box is a device that enables a sink device (150, 160, 170) to become a user interface to the Internet or enables a sink device to receive and decode digital television (DTV) broadcasts. DTV set-top boxes are sometimes called receivers. A set-top box may contain a Web browser (a Hypertext Transfer Protocol client) and the Internet's main program, TCP/IP.

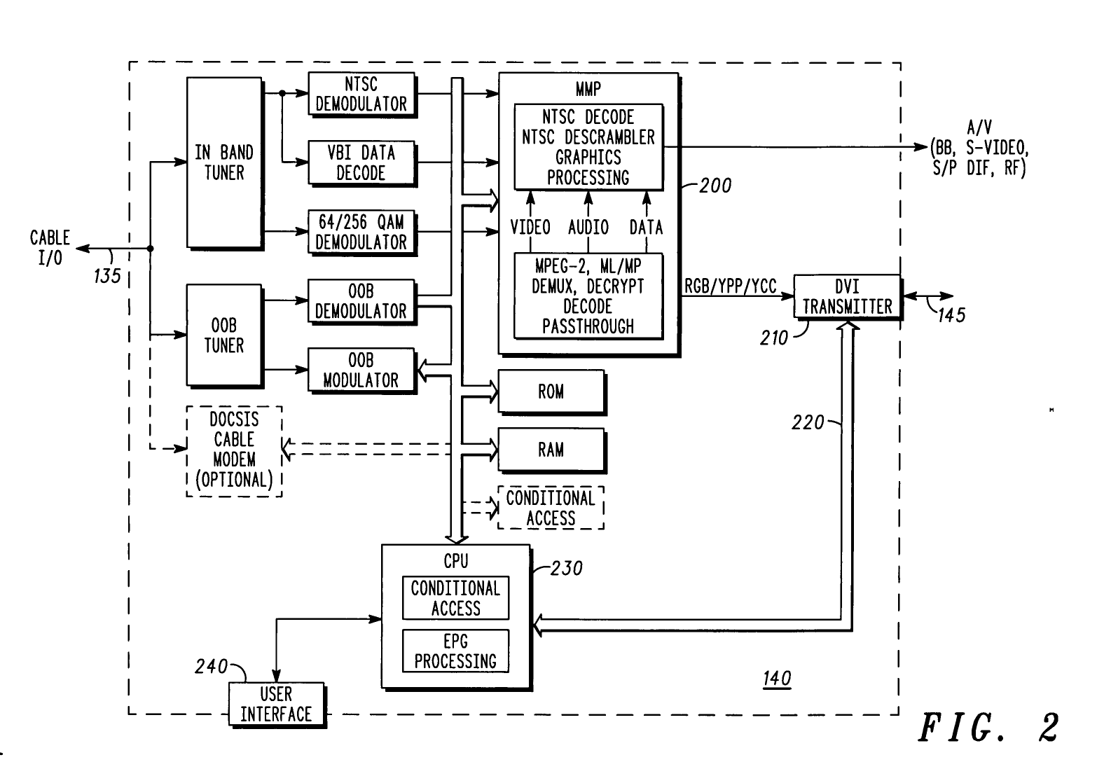

FIG. 2 is a block diagram illustrating the internal components of a source device (140) such as a set-top box. As shown in FIG. 2, the source device (140) may include, but is in no way limited to, a cable input/output (135) for receiving a video signal, a micro-programmable multi processor (200), a DVI or HDMI input/output (145) for transmitting a video signal containing closed caption data to a number of sink devices (150, 160, 170), a central processing unit (230) for running the operating system, an I2C bus (220) for communicatively coupling the central processing unit (CPU) to the DVI or HDMI input output (145), a user interface (240), random access memory (RAM), read only memory (ROM), and a number of chips for audio as well as video decoding and processing. A number of the internal components of the exemplary source device (140) will be described in detail below.

The cable input/output (135) for receiving a video signal illustrated in FIG. 2 couples the head-end unit (130) to the source device (140). The cable input/output (135) may be any input/output connector configured to facilitate communication with the head-end unit (130) including, but in no way limited to, coaxial cable, twisted pair cable, fiber optic cable, etc.

The micro-programmable multi processor (200) illustrated in FIG. 2 is a programmable circuit that receives data signals from an in-band tuner. The microprogrammable multi processor (200), upon receiving the data signals, may separate the data signals into closed caption data and/or video/audio packets. Moreover, the microprogrammable multi processor (200) may be configured by the central processing unit (230) to selectively pass closed caption data to specified sink devices (150, 160, 170; FIG. 1) through the DVI/HDMI output/input (145).

The DVI and/or HDMI input/output (145) illustrated in FIG. 2 is a connector and port configured to selectively transmit a video and audio signal containing closed caption data to a number of sink devices (150, 160, 170; FIG. 1). More specifically, the DVI input/output may be any connector and port that accommodates analog and digital display devices with a single connector. Similarly, the HDMI input/output may be any connector and port that combines video and audio into a single digital interface for use with audiovisual devices.

The central processing unit (230) illustrated in FIG. 2 is configured to run the operating system. More specifically, the central processing unit (230) contains the logic circuitry that is configured to access a number of data storage units which, when accessed, cause the central processing unit to perform the present method. Additionally, the central processing unit (230) may configure the micro-programmable multi processor (200) in response to data received through the I2C bus (220).

The I2C bus (220) illustrated in FIG. 2 communicatively couples the central processing unit (230) to the DVI or HDMI input/output (145). The I2C (Inter-IC) bus is a bi-directional two-wire serial bus that may provide a communication link between the central processing unit (230) and any communicatively coupled sink devices (150, 160, 170; FIG. 1). There are three data transfer speeds for the I2C bus: standard, fast-mode, and high-speed mode. Standard is 100 Kbps. Fast-mode is 400 Kbps, and high-speed mode supports speeds up to 3.4 Mbps. Moreover, all of the modes are backward compatible. The I2C bus supports 7-bit and 10-bit address space devices and devices that operate under different voltages. Any of the above-mentioned I2C bus (220) configurations may be implemented with the present system and method.

The user interface (240) disposed on the exemplary source device (140) illustrated in FIG. 2 allows for interaction between the source device and a user. The user interface (240) may be any user interface including, but in no way limited to a graphical user interface (GUI).

Returning again to FIG. 1, the source device (140) is communicatively coupled to the sink devices (150, 160, 170) via a DVI and/or HDMI connection (145). A DVI connection is a specification created by the Digital Display Working Group to accommodate analog and digital monitors with a single connector. Using a DVI connector and port, a digital signal that is sent to an analog monitor is converted into an analog signal. If the monitor is a digital monitor, such as a flat panel display, no conversion is necessary. Similarly, a HDMI connection is a specification that combines video and audio into a single digital interface for use with any number of sink devices (150, 160, 170). HDMI supports standard, enhanced, or high-definition video plus standard to multi-channel surround-sound audio. HDMI benefits include uncompressed digital video, a bandwidth of up to 5 gigabytes per second, one connector instead of several cables and connectors, and communication between the source device (140) and the sink device (150, 160, 170).

The sink devices (150, 160, 170) illustrated in FIG. 1 are communicatively coupled to the source device (140) through the DVI/HDMI connection (145). Sink devices (150, 160, 170) that maybe implemented in the present exemplary setup (100) include any video display device including, but in no way limited to, a computer monitor (170), a high-definition television (160), a video projector (150), a personal digital assistant (not shown), a cell phone, or any other audiovisual device.

Exemplary Implementation and Operation

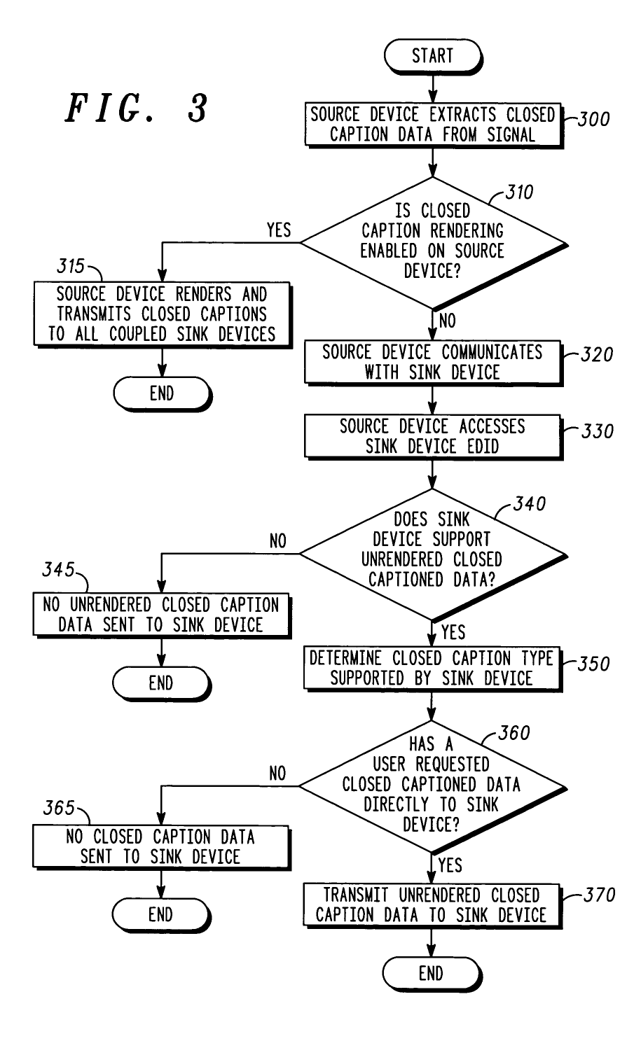

FIG. 3 illustrates a method for operating the exemplary setup (100) illustrated in FIG. 1 to selectively pass closed caption data over a DVI and/or HDMI connection (145; FIG. 1) according to one exemplary embodiment. As illustrated in FIG. 3, the present method begins by the source device extracting un-rendered closed caption data from a received signal (step 300). When the signal is received and the closed caption data has been extracted, the source device determines whether the rendering function on the source device has been enabled (step 310). If the rendering function on the source device has be enabled (YES, step 310), the source device renders and transmits the closed caption data to all of the sink devices that are coupled to the DVI/HDMI connection (step 315). If, however, the rendering function on the source device has not been enabled (NO, step 310), the source device communicates with a coupled sink device through the DVI/HDMI connection (step 320). Once communication has been established, the source device accesses the extended display identification data (EDID) corresponding to the coupled sink device (step 330).

EDID data is used by the source device to determine whether or not the coupled sink device supports un-rendered closed caption data (step 340). If the source device determines that the coupled sink device does not support un-rendered closed caption data (NO, step 340), then no un-rendered closed caption data is transmitted to the sink device (step 345). If, however, the coupled sink device does support un-rendered closed caption data (YES, step 340), then source device determines what closed caption type is supported by the sink device (step 350).

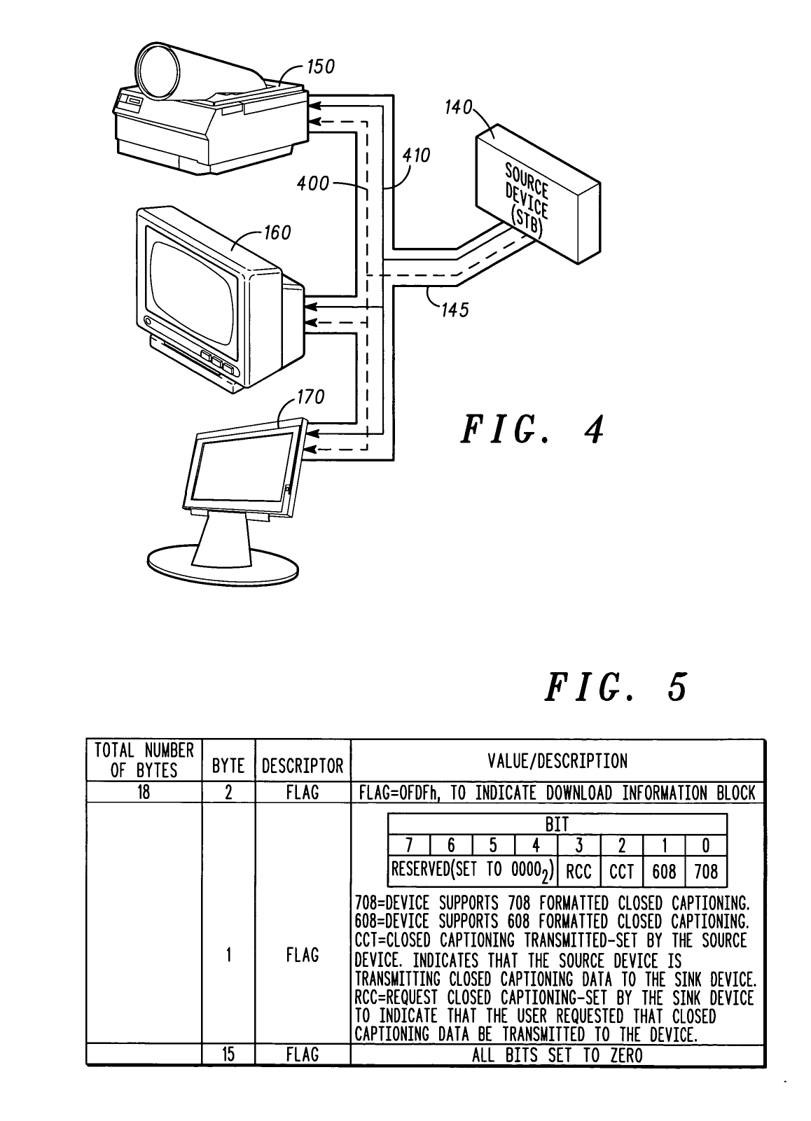

The source device also determines whether the user of the sink device has requested un-rendered closed caption data to be sent directly to the sink device (step 360). If the user has not requested un-rendered closed caption data to be sent directly to the sink device (NO, step 360), then no un-rendered closed caption data is sent to the sink device (step 365). If, on the other hand, the user has requested un-rendered closed caption data to be sent directly to the sink device (YES, step 360), then the source device transmits un-rendered closed caption data to the sink device (step 370). The details of each step illustrated in FIG. 3 will now be explained with reference to FIGS. 4 and 5.

As shown in FIG. 3, the present method begins as the source device receives a video signal including closed caption data and extracts the closed caption data from the received signal (step 300). According to one exemplary embodiment, when the source device (140; FIG. 1) receives digital data packages from a head-end unit (130; FIG. 1), the digital data packages representing auxiliary information are extracted from the original signal. The auxiliary information representing the closed caption data may then be identified and removed.

Once the source device has received the signal and extracted the closed caption data from the received signal, the source device determines whether the closed caption rendering function of the source device (140; FIG. 1) has been enabled (step 310). The rendering function would be enabled on the source device through the user interface (240; FIG. 2) on the source device. When the rendering function of the source device (140; FIG. 1) is enabled (YES, step 310), the closed caption data packets received by the source device (140; FIG. 1) are rendered and inserted into the data signal. Once inserted into the data signal, the video and the closed caption are transmitted to the communicatively coupled sink devices (150, 160, 170; FIG. 1) where they are displayed (step 315). According to this embodiment, when the closed caption rendering function has been enabled, the sink devices (150, 160, 170; FIG. 1) have no control over the display of the closed captions.

If, however, the user does not enable the closed caption rendering function on the source device (NO, step 310), the closed captions will not be rendered or inserted in the data signal to be automatically be displayed by all of the sink devices (150, 160, 170; FIG. 1). Rather, when the rendering function is not enabled on the source device (140; FIG. 1), the source device communicates with the coupled sink devices (step 320). Communication between the source device (140; FIG. 1) and the sink devices (150, 160, 170; FIG. 1) may be both enabled and performed through the two-way communication capabilities of the DVI/HDMI connection.

Once communication has been established between the source device and the sink devices, the source device accesses an extended display identification data (EDID) of the sink device (step 330). The extended display identification data (EDID) is a data structure provided by each sink device (150, 160, 170; FIG. 1) to describe its capabilities to a source device (140; FIG. 1). The EDID enables a source device (140; FIG. 1) to know what kind of sink device (150, 160, 170; FIG. 1) is coupled thereto. The EDID is defined by a standard published by the Video Electronics Standards Association (VESA) and includes manufacturer name, product type, phosphor or filter type, timings supported by the sink device, sink size, luminance data, and pixel mapping data (for digital sink devices only).

The channel for transmitting the EDID from the sink device(150, 160, 170; FIG. 1) to the source device (140; FIG. 1) is usually the I2C bus (220; FIG. 2). The combination of EDID and I2C is called the display data channel version 2, or DDC2. The EDID is often stored by the sink device (150, 160, 170; FIG. 1) in a memory device such as a serial PROM (programmable read-only memory) or EEPROM (electrically erasable PROM) that is compatible with the I2C bus (220; FIG. 2).

According to one exemplary embodiment, in addition to the information listed above, the EDID may also include a modified monitor descriptor block as illustrated in FIG. 5. As shown in FIG. 5, the modified monitor descirptor block (500) includes bits that, when set, indicate what format of closed captioning is supported by the sink device (150, 160, 170; FIG. 1), whether the sink device has requesetd the transmission of closed captioning data, and whether the closed captioning data has been transmitted by the source device. As shown in FIG. 5, a bit of the modified monitor descriptor block labeled bit “0,” when set, indicates to the source device that the sink device supports 708 formatted closed captioning. Similarly, a bit of the modified monitor descriptor block (500) labeled bit “1,” when set, indicates to the source device that the sink device supports 608 formatted closed captioning. Moreover, a bit of the modified monitor descriptor block (500) labeled bit “2,” when set, indicates that the source device is transmitting closed caption data to the sink device. Additionally, the bit of the modified monitor descriptor block (500) labeled bit “3,” when set, indicates that the user requeseted that closed captionoin data be transmitted to the device.

Once the EDID is accessed, the source device (140; FIG. 1) determines whether the sink device (150, 160, 170; FIG. 1) supports un-rendered closed caption data (step 340; FIG. 3). As noted above with reference to FIG. 5, the source device (140; FIG. 1) may determine from bit settings of the modified monitor descriptor block (500) whether the sink device supports un-rendered closed captioning data. While the illustrated embodiment of the present system and method is presented within the context of using a modified monitor descriptor block (500) to obtain information about the sink device, the present system and method is in no way limited to this embodiment.

If the sink device (150, 160, 170; FIG. 1) does not support un-rendered closed caption data (NO, step 340), then no un-rendered closed caption data is sent to the sink device (step 345). According to this embodiment, if closed captions are desired by a user on a sink device that does not support un-rendered closed caption, the rendering function on the source device may be activated causing all of the sink devices to display the closed caption data.

If, however, the sink device does support un-rendered closed caption data (YES, step 340), the source device determines what type of un-rendered closed captions are supported by the sink device (step 350). Again, the source device (140; FIG. 1) may access the modified monitor descriptor block (500; FIG. 5) to determine the types of closed caption formats supported by the sink device.

Once the type of supported formats have been determined, the source device (140; FIG. 1) determines whether the user has requested the reception of closed caption data directly to the sink device (step 360). Through communication between the source device (140; FIG. 1) and the modified monitor descriptor block provided by the sink device (150, 160, 170; FIG. 1), the source device may obtain this information. If no un-rendered closed captions have been requested (NO, step 360), then no un-rendered closed caption data is sent to the sink device.

If, however, the user has requested the reception of closed caption data directly to the sink device (YES, step 360), then the request is granted and un-rendered closed caption data is sent to the sink device (step 370) through the DVI/HDMI interface.

FIG. 4 illustrates how the un-rendered closed caption data may be sent to the sink devices (150, 160, 170) according to one exemplary embodiment. As shown in FIG. 4, the sink devices (150, 160, 170) are communicatively coupled to the source device (140) through a DVI/HDMI connection (145). The source device (140) transmits independent packets of data. One packet of data transmitted to each of the sink devices (150, 160, 170) includes audio and/or video data (400). The other packets of data transmitted by the source device (140) illustrated in FIG. 4 are un-rendered closed caption data. By separating the closed caption data (410) from the audio and/or video data (400), the present system and method allow for each sink device (150, 160, 170) to locally render the closed caption data (410) when requested by a user. Once requested by a user, the sink device may use its own internal circuitry to locally and selectively render and display the closed caption data (410).

The present system and method allow a user to have multiple options with respect to displaying closed captioning when closed captioning is enabled. First, the source device may be set so as to decode and render the closed captioning directly with the received video causing all coupled sink devices to display the closed captions. Secondly, the source device may be set so as to pass closed captioning data to the sink device for selective local decode and rendering via the sink device.

In conclusion, the present method and system for passing closed caption data over a digital visual interface and/or high definition multimedia interface for localized rendering, in its various embodiments, allows for independent sink devices to locally render closed caption material received via a DVI/HDMI. Specifically, the present system and method provides a system and a method for a source device to determine whether a sink device is configured to receive and render closed caption material. Moreover, the present system and method allow a source device to selectively transmit un-rendered closed caption data to requesting and sufficiently enabled sink devices.

The preceding description has been presented only to illustrate and describe the present method and system. It is not intended to be exhaustive or to limit the present method and system to any precise form disclosed. Many modifications and variations are possible in light of the above teaching.

The foregoing embodiments were chosen and described in order to illustrate principles of the method and system as well as some practical applications. The preceding description enables others skilled in the art to utilize the method and system in various embodiments and with various modifications as are suited to the particular use contemplated. It is intended that the scope of the method and system be defined by the following claims.

1. A method for selectively passing closed caption data from a source device to a display device comprising:
receiving a data signal in said source device, said data signal including un-rendered closed caption data and video data;
separating said video data from said un-rendered closed caption data;
determining closed caption processing capabilities of said display device; and
if said display device is configured to process un-rendered closed caption data, transmitting said un-rendered closed caption data to said display device.

2. The method of claim 1, wherein said un-rendered closed caption data is sent to said display device only upon request by said display device.

3. The method of claim 1, wherein said determining closed caption processing capabilities of said display device comprises:
communicating with said display device via said source device;
accessing extended display identification data (EDID) corresponding to said display device; and
determining closed caption processing capabilities of said display device based on said EDID.

4. The method of claim 3, wherein said communication with said display device occurs over a digital visual interface (DVI).

5. The method of claim 3, wherein said communication with said display device occurs over a high definition multimedia interface (HDMI).

6. The method of claim 1, further comprising rendering said closed caption data in said source device if said display device is not configured to process un-rendered closed caption data.

7. A system for selectively passing closed caption data from a source device to a display device comprising:
a source device; and
a sink device communicatively coupled to said source device;
wherein said source device is configured to receive a data signal including unrendered closed caption data and video data, separate said video data from said un-rendered closed caption data, determine closed caption processing capabilities of said sink device, and if said sink device is configured to process un-rendered closed caption data, transmit said unrendered closed caption data to said sink device.

8. The system of claim 7, wherein said source device comprises a set-top box.

9. The system of claim 7, wherein said sink device comprises one of a digital television, a computer monitor, or a projector.

10. The system of claim 7, wherein said source device is communicatively coupled to said sink device via a digital visual interface.

11. The system of claim 7, wherein said source device is communicatively coupled to said sink deice via a high-definition multimedia interface.

12. The system of claim 7, wherein said source device is configured to be communicatively coupled to a head-end unit.

13. The system of claim 7, wherein said source device comprises:
a number of data storage units;
a central processing unit;
a digital visual interface input/output;
an I2C bus communicatively coupling said central processing unit and said digital visual interface input/output; and
a processor communicatively coupled to said central processing unit and said digital visual interface input/output.

14. The system of claim 13, wherein said source device is configured to determine closed caption processing capabilities of said sink device through said digital visual interface input/output.

15. A system for selectively passing closed caption data from a source device to a display device comprising:
signal processing means for receiving and processing a video and closed caption containing signal; and
display means communicatively coupled to said signal processing means;
wherein said signal processing means is configured to receive a data signal including un-rendered closed caption data and video data, separate said video data from said un-rendered closed caption data, determine closed caption processing capabilities of said display means, and if said display means is configured to process un-rendered closed caption data, transmit said un-rendered closed caption data to said display means.

16. The system of claim 15, wherein said signal processing means comprises a set-top box.

17. The system of claim 15, wherein said display means comprises one of a digital television, a computer monitor, or a projector.

18. The system of claim 15, wherein said processing means is communicatively coupled to said display means via a digital visual interface.

19. The system of claim 15, wherein said processing means is communicatively coupled to said display means via a high-definition multimedia interface.

20. A source device configured to selectively pass closed caption data from a source device to a display device comprising:
a number of data storage units;
a central processing unit;
a digital visual interface input/output;
an I2C bus communicatively coupling said central processing unit and said digital visual interface input/output; and
a processor communicatively coupled to said central processing unit and said digital visual interface input/output;
wherein said source device is configured to receive a data signal including un-rendered closed caption data and video data, separate said video data from said un-rendered closed caption data, determine closed caption processing capabilities of a communicatively coupled display device, and if said display device is configured to process un-rendered closed caption data, transmitting said un-rendered closed caption data to said display device.

21. The source device of claim 20, wherein said source device is configured to determine closed captioning processing capabilities of a communicatively coupled device by accessing said coupled devices extended display identification data (EDID).

22. The source device of claim 21, wherein said EDID is communicated through said digital visual interface input/output.

23. The source device of claim 20, wherein said source device comprises a set-top box.

24. A monitor descriptor block comprising:
a first bit, wherein the setting of said first bit indicates a closed caption capability of an associated monitor;
a second bit, wherein the setting of said second bit indicates that said associated monitor requests that un-rendered closed captioning data be transmitted to said associated monitor; and
a third bit, wherein the setting of said third bit indicates that a source device has transmitted closed captioning data to said associated monitor.

25. The monitor descriptor block of claim 24, further comprising a plurality of bits, each of said bits indicating a different closed captioning format capability.

26. A processor readable carrier including processor instructions that instruct a processor to perform the steps of:
receiving a data signal, said data signal including un-rendered closed caption data and video data;
separating said video data from said un-rendered closed caption data;
determining closed caption processing capabilities of a coupled display device; and
if said display device is configured to process un-rendered closed caption data, transmitting said un-rendered closed caption data to said display device.

27. The processor readable carrier of claim 26, wherein said processor instructions further instruct a processor to only transmit said un-rendered closed caption data to said display device upon request from said display device.

28. The processor readable carrier of claim 26, wherein said determining closed caption processing capabilities of said display device comprises:
communicating with said display device;
accessing an extended display identification data (EDID) corresponding to said display device; and
determining closed caption processing capabilities of said display device based on said EDID.

29. The method of claim 28, wherein said communication with said display device comprises communication via a digital visual interface (DVI).

30. The method of claim 28, wherein said communication with said display device comprises communication via a high definition multimedia interface (HDMI).
